(19) United States
(12) Patent Application Publication
(10) Pub. No.: US 2006/0067776 A1
(43) Pub. Date: Mar. 30, 2006

(54) Paper cutting device, paper post processing device, and image forming system

(76) Inventors: Masahiro Kaneko, Tokyo (JP); Toshio Shida, Tokyo (JP); Hiroyuki Wakabayashi, Tokyo (JP)

Correspondence Address: CANTOR COLBURN, LLP, 55 GRIFFIN ROAD SOUTH, BLOOMFIELD, CT, 06002, US

(21) Appl. No.: 11/113,836

(22) Filed: Apr. 25, 2005

(30) Foreign Application Priority Data
Sep. 27, 2004 (JP) JP2004-279015

(51) Int. Cl. B41J 11/70

(52) U.S. Cl. 400/621

(57) ABSTRACT

There is described a paper cutting device which is suitably used as a part of an image forming system, a paper processing device including the paper cutting device, and an image forming system. The paper cutting device includes a cutter blade having a long shape, being provided slidablly in a longitude direction thereof; a cutter blade driving device to move the cutter in a direction traverse to a surface of the set of sheets for cutting. The cutter blade driving device is provided at one side of the cutter blade and the cutter blade is changeable from the other side of the cutter blade.

This application is based on Japanese Patent Application NO. 2004-279015 filed on Sep. 27, 2004 in Japanese Patent Office, the entire content of which is hereby incorporated by reference.

### BACKGROUND OF THE INVENTION

The present invention relates to a paper cutting device for cutting a plurality of sheets of paper, a paper post processing device including the paper cutting device, and an image forming system having the paper post processing device.

Multifunction image forming systems which have a paper processing device for performing various post processing and which are capable of performing in one device, all of the post processes such as middle folding and saddle stitch and the like for the papers on which images have been formed, are becoming popular as high speed image forming devices such as electrophotographic image forming devices.

The various types of post processing devices have a paper cutting device which aligns the edges of the end of the sheet set having a plurality of sheets, and the paper cutting device described in Japanese Patent Application Laid-Open No. 2003-228205 publication for example, discloses an image forming system which includes a cutting device for cutting fore edges in the paper that has been subjected to middle folding and saddle stitch. This paper cutting device is called a guillotine, and thus cuts by pressing the cutter blade onto the paper surface from the perpendicular direction.

Japanese Patent Application Laid-Open No. 2003-191196 publication discloses a paper cutting device which cuts by pressing the cutter blade onto the paper surface from a diagonal direction.

The cutting device of Japanese Patent Application Laid-Open No. 2003-136471 publication includes a paper press which descends from above and a cutter which ascends from below, and a pin which projects from the cutter fits into the guide groove and the pin is attached by engaging with the groove portion of a receiving member which is provided on a nut which screws into a screw which is rotated by a motor. The cutting device of Japanese Patent Application Laid-Open No. 2001-129788 publication cuts by pressing the cutter blade onto the paper perpendicularly, and the entire cutting device is slidable.

[Patent Document 1] Japanese Patent Application Laid-Open No. 2003-228205 publication

[Patent Document 2] Japanese Patent. Application Laid-Open No. 2003-191196 publication

[Patent Document 3] Japanese Patent Application Laid-Open No. 2003-136471 publication

[Patent Document 4] Japanese Patent Application Laid-Open No. 2001-129788 publication

The guillotine type cutting device described in the Japanese Patent Application Laid-Open No. 2003-228205 publication requires a large force for driving the cutter blade, and in addition, because it is necessary to set the maximum value for the range of power which the driving means uses, problems arise in that a motor with a large amount of electric power is need, and thus the device becomes large and electric power consumption is high. In this case, incorporating a cutting device in the post processing device which forms the image forming system, in particular, is difficult.

In the cutting device of the Japanese Patent Application Laid-Open No. 2003-191196 publication, the stage which supports the paper also functions as a blade receiving member which receives the cutter blade, but the stage is cut out by the cutter blade due to multiple cutting operations and an etched groove is formed. Because of the etched groove, there is the problem that some of the paper remains uncut and the cutting surface becomes uneven.

In the paper cutter blade of the Japanese Patent Application Laid-Open No. 2003-136471 publication, because left and right guide plates of the pair of guide plates which support the cutter blade so as to be slidable are not connected, when a plurality sheets of paper, for example 50˜100 sheets of paper are being cut, the pair of guide plates may fall down and as a result, an extremely large load is applied to the cutter blade. Because of this, the driving load for the cutter blade driving device increases.

In the cutter blade of the Japanese Patent Application Laid-Open No. 2001-129788 publication, the entire cutting device including the cutter blade and the driving portion is formed so that it can be caused to slide and pulled out, and a large space is needed for pulling out. In Patent Documents 1-3, there is no disclosure regarding wear and damage of the cutter blade resulting from continuous use as described above. In addition, in the Japanese Patent Application Laid-Open No. 2001-129788 publication, although blade replacement is described, in order to allow blade replacement, the structure is such that the entire cutting device including the cutter blade and the driving device is moved. The structure in which the entire device is moved requires labor and also space. The structure of the entire device cannot be compact when allowance is made for maintenance and a driving portion for the cutter blade is included.

There thus exists a need to provide a paper cutting device which is suitably used as a part of an image forming system, a paper processing device including the paper cutting device, and an image forming system.

In particular, in the case where the cutting device is used as a part of the image forming system, it is necessary for the device to be compact. As a result, there exists another need to provide a cutting device in which the device is made compact, and the long cutter blade can be effectively replaced.

### SUMMARY OF THE INVENTION

The present invention provides a paper cutting apparatus and an image-forming system described as follow.

(1) An apparatus for cutting a set of sheets, comprising: a cutter blade having a long shape, being provided slidablly in a longitude direction thereof; and a cutter blade driving device to move the cutter in a direction traverse to a surface of the set of sheets for cutting; wherein the cutter blade driving device is provided at one side of the cutter blade and the cutter blade is changeable from the other side of the cutter blade.

(2) An apparatus for cutting a set of sheets, comprising: a cutter blade having a long shape; a holder for holding the cutter blade slidablly in a longitude direction of the cutter blade: and a cutter blade driving device to move the cutter blade in a direction traverse to a surface of the set of sheets for cutting; wherein the cutter blade driving device is provided at a side of the holder and the cutter blade is changeable from the other side of the holder.

(3) An image forming system comprising: an image forming apparatus for forming an image on a sheet; a cutting device for cutting a set of the sheets on which the image is formed; the cutting apparatus including: a cutter blade having a long shape, being provided slidablly in a longitude direction thereof; and a cutter blade driving device to move the cutter blade in a direction traverse to a surface of the set of sheets for cutting; wherein the cutter blade driving device is provided at one side of the cutter blade and the cutter blade is changeable from the other side of the cutter blade.

### BRIEF DESCRIPTION OF THE DRAWINGS

The features and inventive aspects of the present invention will become apparent upon reading the following detailed description and upon reference to the drawings in which:

FIG. 1 is a front view of a paper cutting device embodied in the present invention;

FIG. 2 is a main parts front view and a main parts side view of which shows the paper cutting device when on standby;

FIG. 3 is a main parts front view and a main parts side view which shows the paper cutting device at the start of paper cutting;

FIG. 4 is an expanded cross-sectional view of the cutter blade area and the blade receiving plate area of the paper cutting device;

FIG. 5(a), FIG. 5(b), FIG. 5(c) and FIG. 5(d), are perspective views and a cross-sectional view of each type of sheet sets which will undergo the cutting processing;

FIG. 6(a) and FIG. 6(b) are a perspective view and a cross-sectional view of a cutter blade area of the paper cutting device;

FIG. 7 is a perspective view of a cutter blade and a grip;

FIG. 8 shows a paper post processing device including the paper cutting device embodied in the present invention and the overall structure of the image forming system;

FIG. 9 is a pattern diagram showing a paper conveyance in the middle folding and saddle stitch processing step of a paper post processing device;

FIG. 10 is a right side view of the paper post processing device;

FIG. 11 is a left side view of the paper post processing device; and

FIG. 12(a) and FIG. 12(b) are side surface views of the paper post processing device.

### DETAILED DESCRIPTION OF THE PREFERRED EMBODIMENTS

The following is a description of the embodiments of this invention with reference to the drawings.

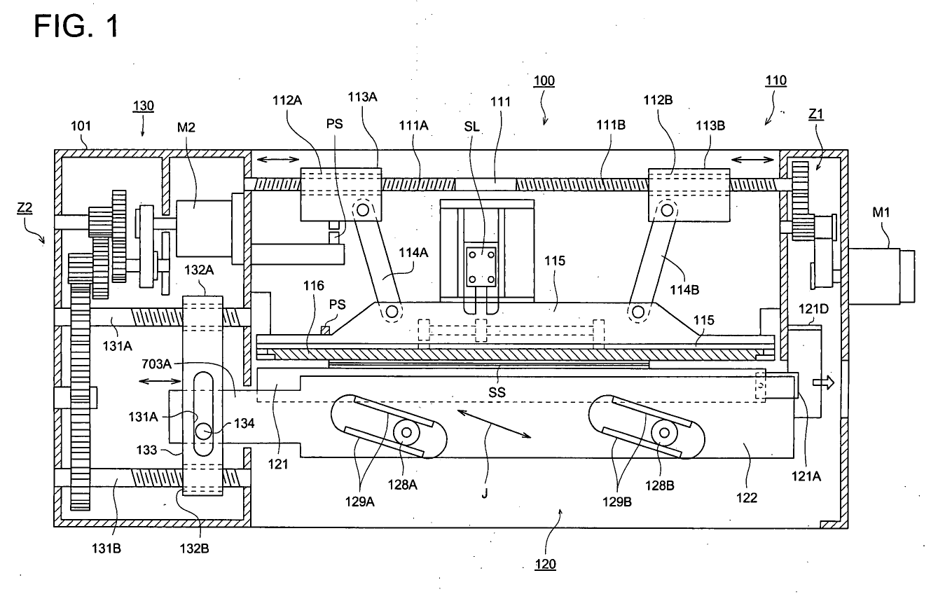

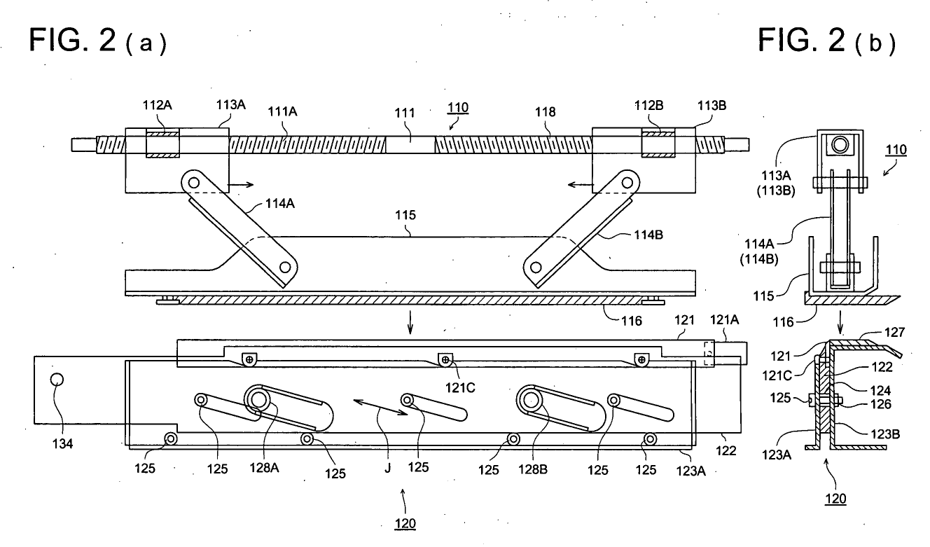

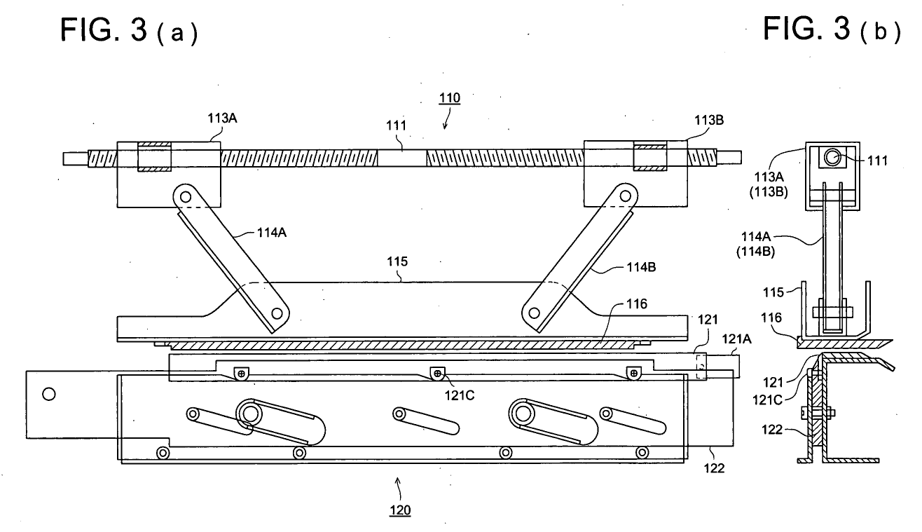

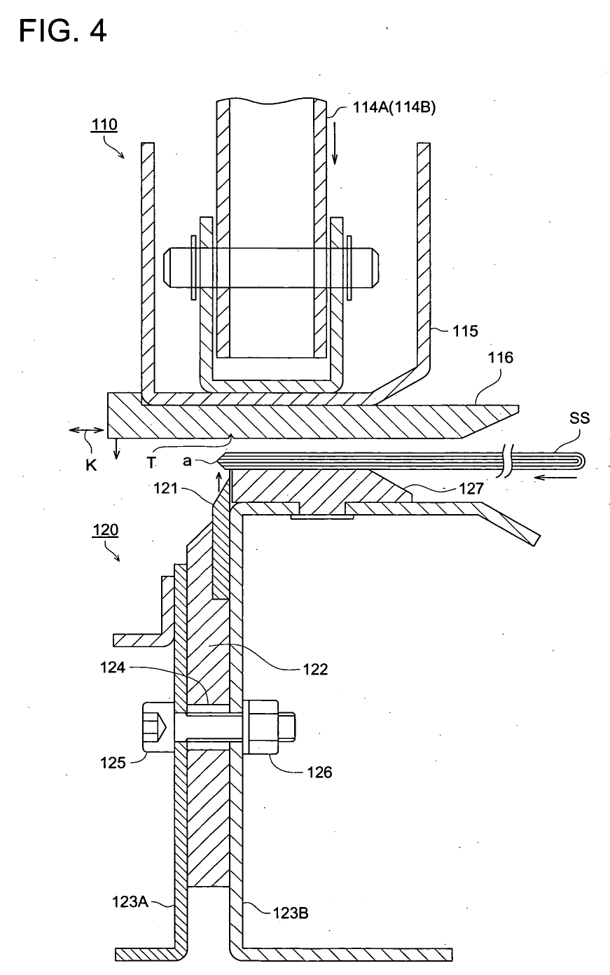

FIG. 1 is a front view of the paper cutting device of this invention. FIG. 2 (a) is a main parts front view of the paper cutting device when on standby, while FIG. 2 (b) is the main parts side view thereof; FIG. 3 (a) is a main parts front view of the paper cutting device showing start of paper cutting starting and FIG. 3 (b) is a main parts side view thereof; FIG. 4 is an expanded cross-sectional view of the cutter blade area and the blade receiving plate area of the paper cutting device.

[Structure of the Paper Cutting Device]

As shown in FIG. 1, in the paper cutting device 100, a cutter blade driving device 130 for moving the cutter blade 121 in direction J is disposed at the left surface side of the main body 101, and when the cutter blade 121 is replaced, the direction in which it is pulled out from the cutter blade holder 122 is at the right surface side of the main body 101. A cutting board moving device 110 is disposed above the middle of the main body 101, while a cutter blade moving device 120 is disposed below the middle of the main body 101. To be more detailed, the cutter blade driving device is disposed at one side in the longitudinal direction of the cutter blade 116 (the left side of FIG. 1 in this embodiment), and the cutter blade 116 may be pulled out at the opposite side (the right side of FIG. 1 in this embodiment).

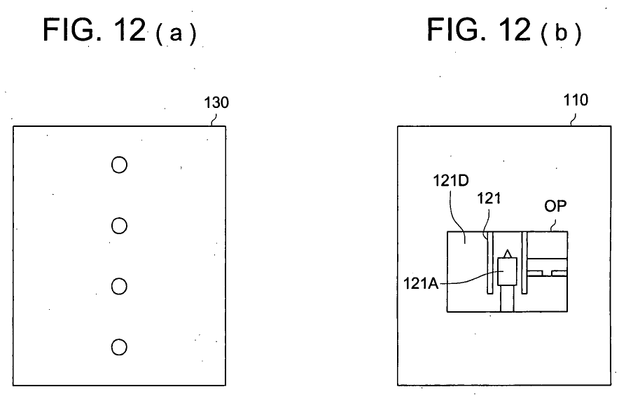

FIG. 12 (a) is a left side view of FIG. 1, while FIG. 12 (b) is a right side view of FIG. 1. As shown in FIG. 12 (a), the left side is shielded by the cutter blade driving device at one side, and as shown in FIG. 12 (b), the right side is formed such that the cutter blade can be pulled out from the opening portion OP.

The fore edges of the sheet set SS which has been conveyed to the paper cutting device 100 is cut by the perpendicular descent of the cutting board which is moved by the cutting board moving device 110 and the diagonal direction ascent of the cutter blade 121 which is moved by the cutter blade moving device 120. The following is a detailed description of the cutting board moving device 110, the cutter blade moving device 120 and the cutter blade driving device 130.

[Blade Receiving Member Moving Means]

The upper portion of the cutting board moving device 110 is provided so as to be suspended with a rotating axle 111 having both ends supported. The rotating axle 111 is rotated by a first driving device having a drive transmission means Z1 which is formed of a motor M1, a belt and a gear wheel.

The rotation axle ill is provided with screw portions 111A and 111B which has twisting angles which are in directions opposite to each other, and the screw portion 111A is screwed so as to fit into the nut 112A, while the screw portion 111B is screwed so as to fit into the nut 112B. Due to the rotation of the rotation axle 111; the moving body 113A which holds the nut 112A and the moving body 113B which hold the nut 112B move linearly in opposite directions to each other.

The lower end of the connecting rod 114A which is supported on one portion of the moving body 113A so as to be swingable engages with the upper left portion shown in the drawing of the small hole pressuring member 115. Similarly, the lower end of the connecting rod 114B which is supported on one portion of the moving body 113B so as to be swingable engages with the upper right portion shown in the drawing of the small hole pressuring member 115, and is supported so as to be capable of ascending.

Accordingly, the rotation axle 111 is rotated due to the driving rotation of the motor M1, and the moving bodies 113A and 113B move horizontally and the incline of the connecting rods 114A and 114B change and the fore edge pressuring member 115 move vertically in parallel.

The cutting board 116 is fixed to the lower surface of the fore edge pressuring member 115, and the moves vertically in parallel with the fore edge pressuring member 115.

In this manner, the first driving device which is formed from the motor M1 and the drive transmission device, the rotation axle 111, the moving bodies 113A and 113B, the connecting rods 114A and 114B, the fore edge pressuring member 115, and the cutting board 116 form the blade receiving plate mechanism.

The fore edge pressuring member 115 which supports the cutting board 116 is driven by a driving mechanism having a large speed reducing ratio and includes the screw portions 111A and 111B, and thus the sheet set SS can be pressed and held with a high pressure.

The fore edge pressuring member 115 which holds the cutting board 116 slides after cutting processes of a prescribed frequency is performed due to a driving device which is not shown, in the direction of arrow K shown in FIG. 4, or in other words, in the direction orthogonal to the longitudinal direction of the cutter blade 121.

[Cutter Blade Moving Means]

The cutter blade moving device 120 is formed from the cutter blade 121, the cutter blade holder 122, a support plates 123A and 123B, a interval holding member 124, a fixing support stage 127, and the fixing device having the connection member 125 and the screw member 126, and the like.

The cutter blade 121 in which the blade tip is formed at the edge of an upper end is fixed and held in the cutter blade holder 122 by the screw member 121 C. The cutter blade holder 122 is supported so as to be movable between the opposing surfaces of the pair of support plates 123A and 123B which are disposed in parallel. The interval holding member 124 is attached so as to be nipped between the opposing surfaces of the support plates 123A and 123B, and the cutter blade holder 122 is held in a movable space.

The connecting member 125 which is screwed by a male screw passes through the support plates 123A and 123B and the interval holding member 124 which forms a hollow cylinder and screws so as to fit into the screw member 126 formed from a spring washer and a hexagonal nut, and the support plates 123A and 123B are held at a prescribed interval and the screws are tightened.

The interval of the opposing sliding surfaces of the support plates 123A and 123B caused by the interval holding member 124 is set in the range of 0.1 to 0.5 mm with respect to the thickness of the cutter blade holder 122, and the cutter blade holder 122 has a space such that it can ascend without any hindrance.

The connecting device formed of the connecting member 125 and the screw member 126 are disposed at a plurality of locations (the 7 locations shown in FIG. 2) of the support plates 123A and 123B, and are held firmly at a prescribed interval.

Rollers 128A and 128B are fixed to the cutter blade holder 122 and the rollers 128A and 128B respectively are guided by guide members 129A and 129B which are inclined downward to the right. The guide members 129A and 129B are fixed on the main body 101.

[Cutter Blade Driving Device]

The cutter blade driving device 130 has a motor M2, a drive transmission means, a moving body 133 and the like.

The main body 101 has rotation axles 131A and 131B which have both ends supported are provided so as to hang in parallel. The rotation axles 131A and 131B in which the screw has been screwed are rotated in the same direction by the second driving device which has a drive transmission device Z2 having a motor M2, a belt and a gear wheel.

The screws that are provided in the rotation axis 131A and 131B are screwed so as to fit into nuts 132A and 132B respectively. Due to the rotation of the rotation axles 131A and 131B, the moving body 133 which holds the nuts 132A and 132B move linearly.

A pin 134 which fixed in the cutter blade holder 122 is inserted so as to be movable into the long hole portion 133A which is formed in the moving body 133. The moving body 133 moves linearly from left to right as shown in the drawing, and due to the linear movement from left to right via the pin 134, the rollers 128A and 128B which are fixed to the cutter blade holder 122 move in the upward diagonal direction as shown by arrow J along the guide members 129A and 129B.

The sheet set SS which is introduced into the paper cutting device 100 is conveyed onto the fixing and support stage 127 of the cutter blade moving device 120 with the fore edges a in front by a conveying device which is not shown, and then stopped at a prescribed position. At this stopping position, the sheet set SS is nipped between the fixing and support stage 127 and the descending cutting board 116, and the fore edges a are cut by the ascending cutter blade 121.

[Operation of the Paper Cutting Device]

Next the operation of the paper cutting device 100 will be described.

In the standby state, the moving body 113A is positioned at the left end while the moving body 113B is positioned at the right end, and the cutting board 116 is at the upper limit position and the cutter blade 121 is on standby at the lower limit position.

When the sheet set SS is introduced into the paper cutting device 100, the motor M1 is started and the moving bodies 113A and 113B are driven, and the fore edge pressuring member 115 descends via the connecting rods 114A and 114B. The motor M1 stops at the position of the fore edge pressuring member 115 that is detected by the detecting means PS and the fore edge pressuring member 115 stops. The stopping position of the fore edge pressuring member 115 is determined by the position setting of the detecting means PS, and the position of the detecting means PS is determined by the number of sheets of paper forming the sheet set SS. Accordingly, in the operation section of the image forming system, the descent position of the fore edge pressuring member 115 is set by the number of sheet of paper forming the set sheet set SS.

The fore edge pressuring member 115 presses the sheet set SS is pressed with a large amount of pressure such that no offsetting occurs when force is applied from the traverse direction by the cutter blade 121 onto the a plurality sheets that have been superposed at the time of paper cutting which is described below.

After the step of pressing the sheet set SS is complete, the motor M1 is started and the cutter blade 121 is moved in the upward left direction of arrow J. The sheet set SS is cut due to this movement of the cutter blade 121. The cutting action of the cutter blade 121 is due to sliding of the blade, and thus cutting using a comparatively small driving force is possible. In addition, even when the number of sheets of paper to be cut is large, only the movement stroke of the cutter blade 121 is changed and the driving force is not changed.

When all of the sheet sets SS have been cut, the tip of the cutter blade 121 comes in contact with the cutting board 116 and the driving force of the cutter blade 121 is increased. This increase in driving force, or in other words the increase in the motor driving current due to increased load of the motor M1 is detected and the control means stops the driving of the motor M1. In this manner, all the papers forming the sheet set SS are cut in this manner.

When the fore edges cutting process is complete, the motor M2 rotates in the opposite direction and the cutter blade 121 descends to a prescribed position in the right diagonal direction in FIG. 1.

When the descent of the cutter blade 121 is complete, the fore edge pressuring member 115 ascends to the start position.

After the ascent of the fore edge pressuring member 115 is complete, when the folding lines pressing member which is not shown and which held the vicinity of the folding line b of the paper stack SS and the receiving plate return to the start position, the fore edge pressuring member 115 and the blade receiving member 116 ascend and the nip on the sheet set SS is released.

Due to the set of operations described above, the fore edges cutting process of the sheet set SS is completed.

Due to repetition of the cutting operation, although only very slight, the cutting board 116 is cut by the cutter blade 121 and as a result, an etched groove T is formed on the cutting board 116. When this etched groove T becomes deep, at times, cutting defects will occur such as, some of the paper will remain uncut or the end surface fore edges a which have been cut will no longer be flat or the like.

In order to prevent this, the cutting board 116 is moved in the direction of arrow K which crosses the longitudinal direction of the cutter blade 121, and the unused portion of the cutting board 116 is set at the position for receiving the blade tip of the cutter blade 121. In other words, the cutting board 116 has a moveable portion which is moveable in the direction of arrow K. In this example, solenoid is used as the moving portion and by actuating the solenoid SL, the cutting board moving device 110 is actuated, and the cutting board 116 advances in the arrow K direction.

As a result, etched grooves T are formed, but the depth can be controlled within a permissible limit and no cutting defects are generated due to the etched grooves.

It is to be noted that it is sufficient for the positional relationship between the cutting board 116 and the cutter blade 121 to be relatively changed in the arrow K direction or in the opposite direction thereto and the cutter blade 121 may be moveable. Because of this structure, generation of grooves in the cutting board 116 is prevented and maintenance properties are improved.

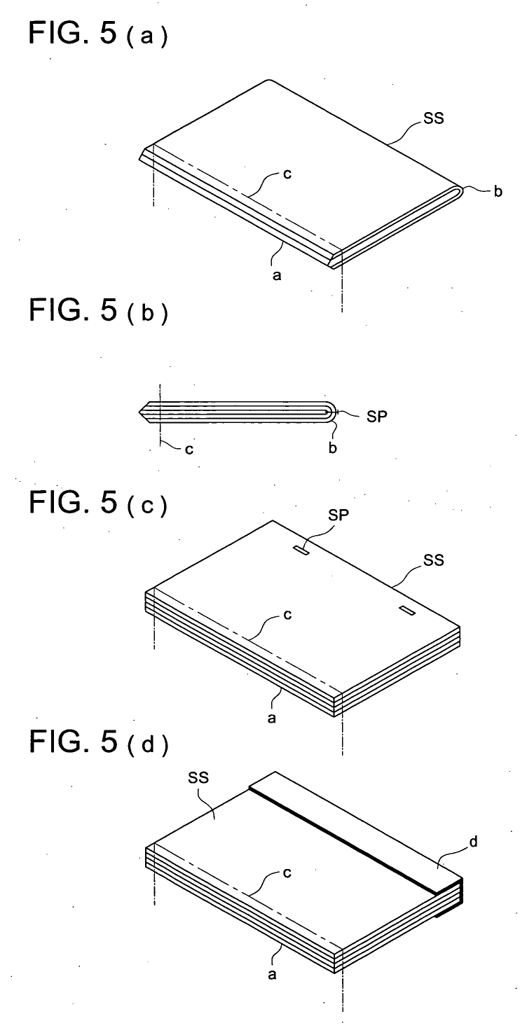

FIG. 5 is a perspective view and a cross-sectional view of each type of sheet set SS which will undergo cutting processing.

FIG. 5 (a) is a perspective view of the sheet set SS which has undergone middle folding and saddle stitch processing and FIG. 5 (b) is a cross-sectional view of the sheet set SS, and a is the fore edge, b is the folding line portion and c is the cutting line and SP is the stitch.

FIG. 5 (c) is a perspective view of the sheet set SS which has undergone side stitch process, and a is the fore edge, c is the cutting line and SP is the stitch.

FIG. 5 (d) is a perspective view of the sheet set SS which has undergone gluing processing, and a is the fore edge, c is the cutting line and d is the adhesive tape.

[Cutter Blade Replacement]

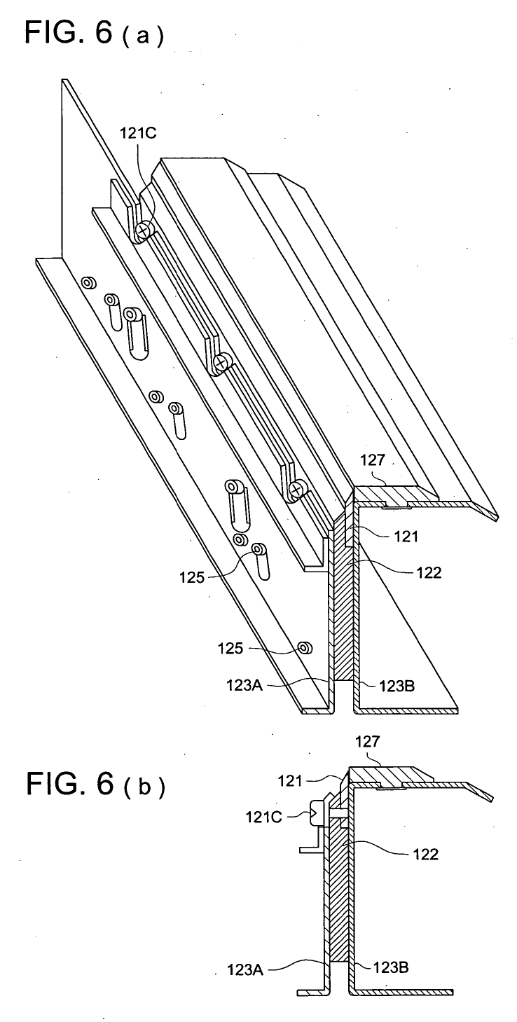

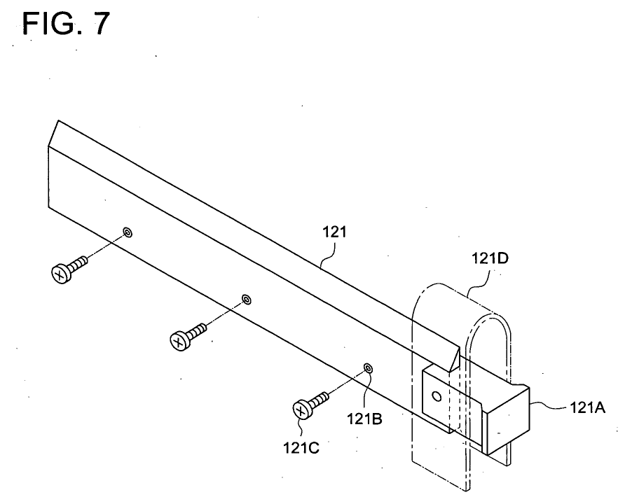

FIG. 6 (a) is a perspective view of the cutter blade 121 area of the paper cutting device 100, and FIG. 6 (b) is a cross-sectional view. FIG. 7 is a perspective view of the cutter blade 121 and the grip 121A.

The grip 121A is fixed to one end of the cutter blade 121. When the cutter blade 121 is being replaced, the operator can hold the grip 121A and easily pull out and push in the cutter blade 121, and accidents due to the operator's finger coming in contact with the tip of the blade is prevented.

The cutter blade 121 is supported at the upper portion of the cutter blade holder 122 and the male screw member 121C engages with the female screw member 121B which is provided by screwing into the cutter blade 121 through the expandable fitting hole which is formed in the cutter blade holder 122, and the cutter blade 121 and the cutter blade holder 122 are firmly tightened and fixed.

When the cutter blade 121 is to be replaced, if the operator first loosens and removes the plurality screw members 121C, the connection between the cutter blade 121 and the cutter blade holder 122 is released. Next, if the grip 121A is held and then pulled out in the direction of the dotted arrow shown in FIG. 1, the grip 121A and the cutter blade 121 which are formed as one unit can be pulled to the outside along the cutter blade holder 122. In other words, as shown in FIG. 1, the structure is such that the cutter blade 121 is pulled out in the direction opposite to the cutter blade driving device 130.

Due to this structure, the cutter blade driving device 130 can be arranged efficiently and the cutter blade 121 can also be smoothly pulled out in its longitudinal direction without buffering the cutter blade holder 122, to thereby do the replacement.

Due to this arrangement, the cutter blade driving device can be efficiently arranged and the falling paper dust or the like is prevented from affecting the driving of the cutter blade. Furthermore, because the pull out direction of the cutter blade 121 is as in this structure, there is no malfunction due to the cutter blade driving device 130 when the cutter blade is replaced, and the user can easily replace the cutter blade. It is preferable that a stopping member is provided at the driving side to prevent pulling out.

It is to be noted that by attaching a protective covering 121D as shown in FIG. 7 to a portion of the main body 101 in the vicinity of the pull out opening for the cutter blade 121 (See FIG. 1), safety is further improved when attaching and detaching the cutter blade 121.

As described above, the cutter blade 121 moves between the upper left (cutting position) and the lower right (steady position) of arrow J direction in FIG. 1. The distance between the cutter blade driving device 130 and the cutter blade 121 is disposed so as to be close at the cutting position and far at the steady position. Due to this structure, at the steady region, the side for replacing the cutter blade 121 is close and thus replacement is easy.

[Paper Post Processing Device Including a Paper Cutting Device and Image Forming System]

A paper post processing device including a paper cutting device and image forming system herein refers to a paper post processing with a built-in paper cutting device or an image processing system that form as a single unit with by adding a paper post processing device including a built-in paper cutting device like that shown in the drawing. It is to be noted that the post processing device with the built-in paper cutting device of this invention may be structured such that it can be used independently. It is also to be noted that the paper post processing device and the image forming system including the paper post processing device is not to be limited by the following embodiments.

[Image Forming Device]

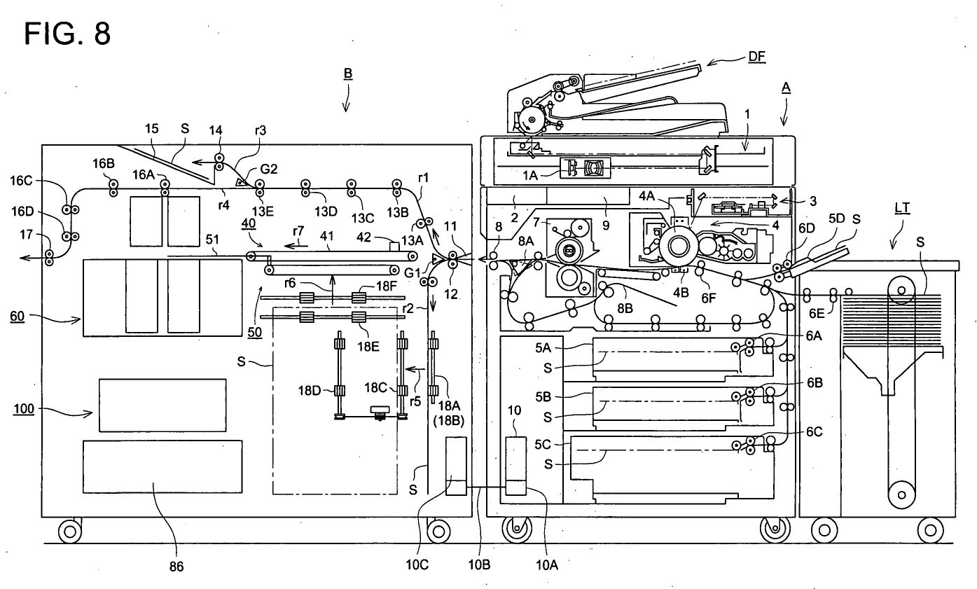

FIG. 8 shows the overall structure of the paper post processing device including the paper cutting device of this invention and the image forming system.

The image forming system comprising the image forming device A, the automatic document feeder DF, the paper post processing device B, and the large volume paper feeding device LT.

The image forming device A shown in the drawing comprises; an image reading section 1; an image processing section 2; an image writing section 3; an image forming section 4; paper feeding cassettes 5A, 5B and 5C; a manual feed tray 5D; first paper feeding sections 6A, 6B, 6C and 6D; a second paper feeding section 6F; a fixing device 7; a paper discharge section 8; and an automatic double-sided copy paper feeding section 8B.

A paper processing device B is connected to the paper discharge section 8 side of the left side surface shown in the drawing of the image forming device A.

Images on one surface or both surfaces of the documents stacked on the document tray of the automatic document feeder DF are read by the optical system of the image reading section 1, and then read in by the CCD image sensor 1A, and the analog signals which have been subjected to photoelectric conversion are sent to the image writing section 3 after being subjected to processing such as analog processing, A/D conversion, shading correction, image compression and the like in the image processing section 2.

In the image writing section 3, the output light from the semiconductor laser is irradiated onto the photoreceptor drum of the image forming section 4A, and a latent image is formed. In the image forming section 4, processes such as charging, exposure, development, transfer, separation, cleaning and the like are performed. The image on the sheet S which is fed by each of the first paper feeding sections 6A to 6C of the paper feeding cassettes 5A to 5C, the first feeding section 6D of the manual feeding tray 5D and the first paper feeding section 6E of the large volume paper feeding device LT is transferred by the transfer means 4B via the second paper feeding section 6F. The sheet S carrying the image is fixed by the fixing device and then sent from the paper discharge section to the paper post processing device B. Alternatively, the sheet S whose one side has undergone image processing and which was sent to the automatic double-sided copy paper feeding section 8B by the conveying path switching plate 8A is sent once again to the image forming section 4 and after image formation on both surfaces, is discharged from the paper discharge section 8.

The operation section 9 selects and sets the processing functions of the image forming device which is formed from the image forming device A and the paper post processing device B and the like.

The main controlling means 10 of the image forming device A is connected to the paper post processing control means 10C of the paper post processing device B via the communication section 10A and the communication circuit 10B.

[Paper Post Processing Device]

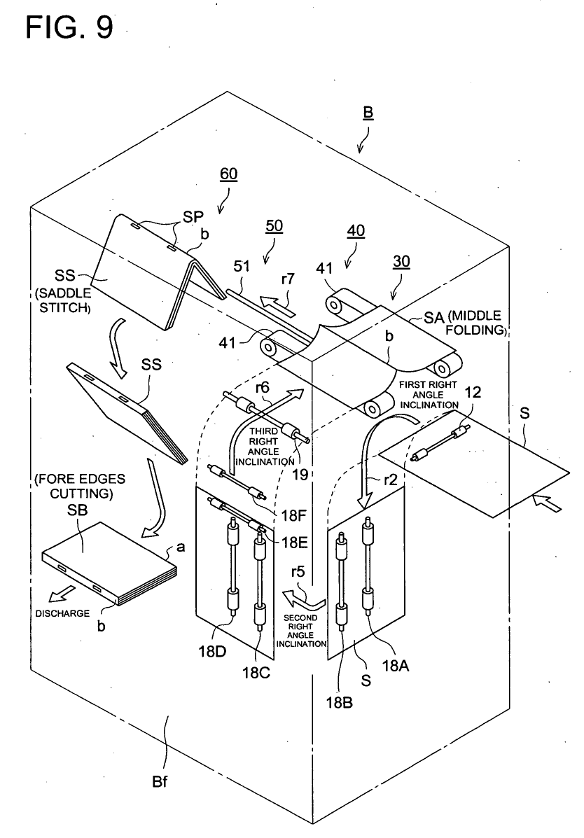

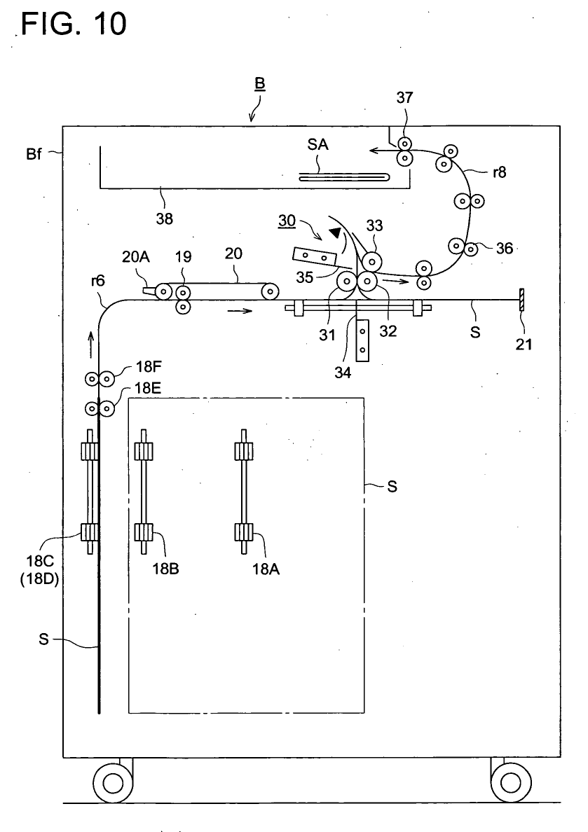

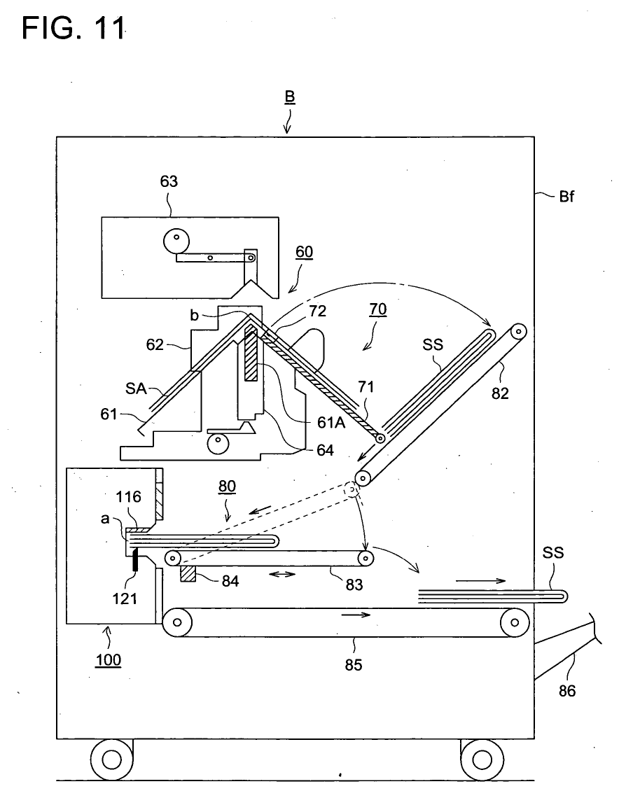

FIG. 9 is a pattern diagram showing paper conveyance in the middle folding and saddle stitch processing step of the paper post processing device B. FIG. 10 is a right side view of the paper post processing device while FIG. 11 is a left side view.

First the paper conveyance steps from the introduction of the paper to the step before the paper folding will be described.

As shown in FIG. 8 and FIG. 9, when the sheet S which is discharged from the image forming device A is introduced into the entrance section 11 of the paper post processing device B, the sheet S is nipped by the entrance roller 12 and is conveyed by one of the upper paper conveying path r1 and the lower paper conveying path r2 of the conveying path switching means G1.

<Straight Discharge Paper>

The sheet S which has branched to the paper conveying path r1 is nipped by the conveyance roller 13A˜13E and conveyed, and then conveyed by the upper paper conveying path r3 or the lower paper conveying path r4 of the conveying path switching means G2.

The sheet S which advanced on the upper paper conveying path r3 is discharged by the discharge roller 14 and is stacked on the sub-discharge tray 15 which is disposed on the upper portion of the paper post processing device B.

The sheet S which advanced on the lower paper conveying path r4 is nipped by conveyance rollers 16A to 16D and conveyed and then discharged by the discharge roller 17.

<First Right Angle Incline Conveyance>

The sheet S which is conveyed on the lower paper conveying path r2 of the conveying path switching means G1 descends substantially at a right angle and temporarily stops at a prescribed position and is stored. At this stop position, the plurality of sheets S which follow are overlapped and stored.

<Second Right Angle Incline Conveyance>

The stored sheet S is moved at an incline in the right-angle front direction with respect to the paper surface in FIG. 8, by the conveyance roller pairs 18A and 18B, the first conveyance roller pairs 18C and 18D, and guide plate which is not shown. The sheet S then passes the paper conveyance path r5 which goes around the front surface side Bf of the inside of the paper post processing device B in a state in which sheet surface is upright and then stops at a prescribed position.

<Third Right Angle Incline Conveyance>

Next, after the sheet S is conveyed upwards perpendicularly by the second conveyance roller pair 18E, it is inclined in the horizontal direction and then moved by the conveyance roller pair 19 and the conveyance alignment belt 20 (see the paper conveying path r6, FIG. 10).

(Alignment Prior to Folding Processing)

As shown in FIG. 10, the alignment means is disposed at the downstream side in the paper conveyance direction of the paper conveyance path r6 and comprises an alignment member 21 for coming in contact with and positioning the front end of the paper and a moveable alignment member 20A which presses the rear end of the sheet S and moves it. The alignment member 20A presses the rear end of the sheets S which are conveyed by the conveying roller pair 19 disposed at the upstream side in the conveyance direction of the paper conveyance path r6, and moves the sheets S to the alignment member 21, and the front end of the sheets comes in contact with alignment member 21 and are thereby aligned.

Next the triple folding process, the middle folding process, the saddle stitch process, and the fore edges cutting process of the bound book which take place in the paper post processing device B are described more specifically.

<Triple Folding Process>

A folding means 30 is disposed at the downstream side in the paper conveyance direction of the conveying alignment belt 20. The folding means 30 comprises folding rollers 31, 32, 33, a first folding plate 34, and a second folding plate 35.

In the case where triple folding is performed, at the folding means 30, the sheets for binding SA in which a first folding line is formed in the sheet S by the folding rollers 31 and 32 and the first folding plate 34, and a second folding line is formed in the sheet S by the folding rollers 32 and 33 and the second folding plate 35, and then subjected to triple folding process passes the paper conveyance path r8 which comprises a plurality conveyance rollers 36 and guide plates, and then discharged to the discharge tray 38 by the discharge roller 37 (See FIG. 10).

<Middle Folding Process>

When the single sheet S or the plurality of sheets S reach the folding means 30, it is nipped by the folding rollers 31 and 32 which rotate in opposite directions to each other and the first folding plate 34 which advances directly, and the middle folding process is then carried out. Sheets for binding SA on which the folding line portion b is formed to extend in the width direction of at the conveyance direction center (see FIG. 10) is then formed.

The sheets for binding SA which underwent double fold processing using the folding rollers 31 and 32 and the first folding plate 34 and on which the folding lines b are formed is separated from the nip position of the folding rollers 31 and 32 due to the reverse rotation of the folding rollers 31 and 32 and returned to the original horizontal conveyance path. Next the sheets for binding SA are conveyed on the paper conveyance path r7 in the direction of extrapolation of the folding line portion b using the conveyance belt 41 of the conveyance means 40 described hereinafter, the conveyance claw 42 and the introduction guide member 51 of the sheets for binding SA guide 50 and then sent to the saddle stitch means 60 (See FIG. 10).

In this manner, the folding means 30 folds the middle of a small number of sheets, such as 1-3 sheets and the folding line portion b is placed firmly, and the sheets are sent to the saddle stitch means 60 and as a result, expansion of the folding line b is small and a high quality sheet set SS can be created.

<Saddle Stitch Processing>

At the folding means 30, the sheets for binding SA which have been subjected to middle folding advances in the direction of the paper conveyance path r7 due to the conveyance means 40 described hereinafter, and is stacked on the saddle stacking means 61 of the saddle stitch means 60. Next the following sheets for binding SA that have undergone middle folding also pass the paper conveyance path r7 and are stacked on the saddle stacking means 61.

The saddle stacking means 61 comprises 2 guide plates which cross substantially at right angles and is fixed on the main body of the paper post processing device B. A pressing member 61A which is urged by a spring and is elevatable is disposed in the vicinity of the crown of the saddle stacking means 61 in a state in which it is supported by the stitch receiving mechanism 64 (See FIG. 10).

The crown portion of the pressing member 61A has a substantially right angular convex shape and the folding line portion b (see FIG. 11) of the sheets for binding SA which have undergone the middle folding process is loaded on the crown portion line thereof.

The position of plurality of sheets for binding SA which are stacked on the saddle stacking means 61 and the pressing member 61A are aligned by the width aligning means 62.

A stitch mechanism 63 is fixed above the pressing member 61A. The pressing member 61A and the stitch receiving mechanism 64 are supported so as to be moveable in the vertical direction inside the saddle stacking means 61.

Two sets of the binding means having the split structure comprising the stitch mechanism 63 and the stitch receiving mechanism 64 are disposed in the direction of the paper folding line portion. When the binding process is set in the operation section, the stitch receiving mechanism 64 moves upwards and performs the binding process. That is to say, 2 sets of binding means are stitched at 2 locations which divide in the center along the folding line portion b of the sheets for binding SA which is above the pressing member 61A. The sheet set SS which has undergone middle folding processing and saddle stitch processing is shown in the pattern diagram of FIG. 9.

<Retrieval of the Bound Book>

The sheet set SS which has undergone saddle stitch processing at the saddle stitch means 60 is held at the support member 72 which is fixed at the front end of the arm member 71 of the bound book retrieving means 70, and is swung in the direction of the single dot chain arrow by the arm member 71, and is conveyed by the bound book conveyance means 80.

<Bound Book Conveyance>

The sheet set SS which has been conveyed by the bound book conveyance means is stacked on the conveyance belt 82. The sheet set SS is conveyed in the lower incline direction due to the rotation of the conveyor belt 82, and is held in an inclined state, and is moved by the rotating conveying belt 83 and stopped at a prescribed position. Subsequently, the conveyor belt 83 swings and is supported in a horizontal state.

<Bound Book Cutting Processing>

The fore edges (the free end at the opposite side of the folding line portion) a of the stacked sheet SS which is loaded on the conveyor belt 83 which is in a horizontal state is not in an aligned state due to the number of sheets in the sheet set SS and thus it is cut by the paper cutting device of this invention and the fore edges a are aligned.

The bound book SSS that is created by the cutting processing is stacked on conveyor belt 83 which rotates in the opposite direction, and the rear end of the bound book SSS is conveyed in a pressed state by the variable aligning member 84 which is fixed on the conveyor belt 83, and falls in the direction of the arrow from the front end of the conveyor belt 83. The bound book SSS that has dropped is discharged to the discharge tray 86 which is disposed at the outer side of the front surface side Bf of the paper post processing device B by the rotating discharge belt 85.

It is to be noted that the paper cutting device 100 is not limited to fore edges cutting processing of the sheet set SS which has undergone middle folding and saddle stitch by the paper post processing device B, and fore edges cutting processing of the sheet set SS which has undergone side stitch processing shown in FIG. 6 (c) or the fore edges cutting processing of the sheet set SS which has undergone gluing processing shown in FIG. 6 (d) may be used.

According to the present invention, the following effects can be attained.

1). A cutter blade driving device is disposed at the back surface side of the paper cutting device in the direction opposite to the direction in which the cutter blade is pulled out from the cutter blade holder and replaced, and by widely extending the space for the replacement operation, replacement of the cutter blade becomes easy and safe for the operator, and can be performed quickly.

2). By providing a grip at the end in the pull-out direction of the cutter blade, the operator may replace the cutter blade by holding the grip and pulling out the cutter blade and this eliminates accidents in which the operator touches the cutter blade and is injured.

3). Disposing a protective cover in the vicinity of the end in the pull-out direction of the cutter blade eliminates accidents in which the operator touches the front end of the blade in the pull-out direction of the cutter blade when the blade is moved in the diagonal direction with respect to the sheet set.

4). Fore edges are cut in the sheet sets that have been subjected to post processing such as middle folding, saddle stitch and the like, and a paper post processing device which creates high quality bound books is realized.

5). An image forming system is realized in which the bound book created by performing post processing on the papers on which images have been performed can be supplied on demand.

Disclosed embodiment can be varied by a skilled person without departing from the spirit and scope of the invention.

What is claimed is:

1. An apparatus for cutting a set of sheets, comprising:
a cutter blade having a long shape, being provided slidablly in a longitude direction thereof; and
a cutter blade driving device to move the cutter in a direction traverse to a surface of the set of sheets for cutting;
wherein the cutter blade driving device is provided at one side of the cutter blade and the cutter blade is changeable from the other side of the cutter blade.

2. The apparatus of claim 1, comprising a cutting board for receiving the cutter blade and pressing the set of sheets.

3. The apparatus of claim 2, wherein the cutting board is provided elevatolly in an up and down direction.

4. The apparatus of claim 1, wherein the holder holds the cutter blade changeable in the longitudinal direction.

5. The apparatus of claim 1, wherein the cutter blade is movable between a cutting position and steady position and the cutter blade is changeable at the steady position.

6. The apparatus of claim 5, a distance between the cutter blade driving device and the cutter blade at the cutting position is longer than the distance at the steady position.

7. The apparatus of claim 2, comprising a moving member for moving the cutting board and the cutting blade in a direction perpendicular to longitudinal direction relatively.

8. The apparatus of claim 7, wherein the moving member moves the cutting board.

9. The apparatus of claim 1, comprising a folder for holding the cutter blade slidablly in a longitude direction.

10. The apparatus of claim 1, a handle is provided on the cutter blade at the changeable side.

11. The apparatus of claim 1, comprising a protective cover, which is located near the cutter blade changeable side.

12. The apparatus of claim 1, wherein the cutting blade has an upward blade edge.

13. An apparatus for cutting a set of sheets, comprising:
a cutter blade having a long shape;
a holder for holding the cutter blade slidablly in a longitude direction of the cutter blade: and
a cutter blade driving device to move the cutter blade in a direction traverse to a surface of the set of sheets for cutting;
wherein the cutter blade driving device is provided at a side of the holder and the cutter blade is changeable from the other side of the holder.

14. The apparatus of claim 13, a handle is provided on the cutter blade at the changeable side.

15. The apparatus of claim 1, comprising a protective cover which is located near the cutter blade changeable side.

16. The apparatus of claim 13, wherein the cutter blade is movable between a cutting position and a steady position and the cutter blade is changeable at the steady position.

17. The apparatus of claim 16, a distance between the cutter blade driving device and the cutter blade at the cutting position is longer than the distance at the steady position.

18. The apparatus of claim 14, comprising a stopper for preventing the cutter blade to slide to the cutter blade driving device.

19. An image forming system comprising:
an image forming apparatus for forming an image on a sheet;
a cutting device for cutting a set of the sheets on which the image is formed;
the cutting apparatus including:
a cutter blade having a long shape, being provided slidablly in a longitude direction thereof; and
a cutter blade driving device to move the cutter blade in a direction traverse to a surface of the set of sheets for cutting;
wherein the cutter blade driving device is provided at one side of the cutter blade and the cutter blade is changeable from the other side of the cutter blade.
